(19) United States
(12) Patent Application Publication
(10) Pub. No.: US 2013/0223528 A1
(43) Pub. Date: Aug. 29, 2013

(54) METHOD AND APPARATUS FOR PARALLEL ENTROPY ENCODING/DECODING

(71) Applicants: Sung Chang Lim, Daejeon (KR); Hui Yong Kim, Daejeon (KR); Se Yoon Jeong, Daejeon (KR); Suk Hee Cho, Daejeon (KR); Jong Ho Kim, Daejeon (KR); Ha Hyun Lee, Seoul (KR); Jin Ho Lee, Daejeon (KR); Jin Soo Choi, Daejeon (KR); Jin Woong Kim, Daejeon (KR); Chie Teuk Ahn, Daejenon (KR); Dong Gyu Sim, Seoul (KR); Sea Nae Park, Seoul (KR); Eun Kyung Ryu, Seoul (KR); Seoung Jun Oh, Seongnam-si (KR); Gwang Hoon Park, Seongnam-si (KR)

(72) Inventors: Sung Chang Lim, Daejeon (KR); Hui Yong Kim, Daejeon (KR); Se Yoon Jeong, Daejeon (KR); Suk Hee Cho, Daejeon (KR); Jong Ho Kim, Daejeon (KR); Ha Hyun Lee, Seoul (KR); Jin Ho Lee, Daejeon (KR); Jin Soo Choi, Daejeon (KR); Jin Woong Kim, Daejeon (KR); Chie Teuk Ahn, Daejenon (KR); Dong Gyu Sim, Seoul (KR); Sea Nae Park, Seoul (KR); Eun Kyung Ryu, Seoul (KR); Seoung Jun Oh, Seongnam-si (KR); Gwang Hoon Park, Seongnam-si (KR)

(73) Assignee: Electronics and Telecommunications Research Institute, Daejeon (KR)

(21) Appl. No.: 13/879,968

(22) PCT Filed: Nov. 15, 2011
(86) PCT No.: PCT/KR2011/008724

§ 371 Date: Apr. 17, 2013

(30) Foreign Application Priority Data
Nov. 15, 2010 (KR) 10-2010-0113127
Nov. 15, 2011 (KR) 10-2011-0119118

(51) Int. Cl. H04N 7/26

(52) U.S. Cl. CPC H04N 19/00951
USPC 375/240.12

(57) ABSTRACT

The present invention relates to an entropy encoding method comprising the following steps: updating probability information using the update information derived based on a bit stream received from an encoder; deriving a bin corresponding to the current codeword based on the updated probability information; and performing the inverse binarization of the derived bin to acquire a syntax element. According to the present invention, video-encoding/decoding efficiency may be improved.

### TECHNICAL FIELD

The present invention relates to image processing, and more particularly, to an entropy encoding/decoding method and apparatus.

### BACKGROUND ART

In recent years, as a broadcasting service having (high definition) HD resolution has extended worldwide as well as domestically, a lot of users are now familiar with high-resolution, high-definition images, and as a result, a lot of companies have spurred the development of next-generation video equipment. Further, with the increase of the concern about ultra high definition (UHD) having resolution which is four times higher than an HDTV in addition to an HDTV, compression technology for higher resolution and high-definition images has been required.

An inter prediction technology of predicting a pixel value included in a current picture from temporarily prior and/or post picture, an intra prediction technology of predicting the pixel value included in the current picture by using pixel information in the current picture, and an entropy encoding technology of allocating a short code to a symbol which has a high occurrence frequency and allocating a long code to a symbol which is a low occurrence frequency may be used for image compression.

### DISCLOSURE

### Technical Problem

The present invention provides an image encoding method and apparatus that can improve image encoding/decoding efficiency.

The present invention also provides an image decoding method and apparatus that can improve image encoding/decoding efficiency.

The present invention also provides an entropy encoding method and apparatus that can improve image encoding/decoding efficiency.

The present invention also provides an entropy decoding method and apparatus that can improve image encoding/decoding efficiency.

### Technical Solution

In an aspect, there is provided an entropy decoding method. The method includes: updating probability information by using update information derived based on a bitstream received from an encoder; deriving a bin corresponding to a current codeword based on the updated probability information; and acquiring a syntax element by inversely binarizing the derived bin, and the probability information includes probability section information and representative probability information, the probability section information includes information on intervals between a plurality of probability sections and the number of the plurality of probability sections, and the representative probability information includes a representative probability for each of the plurality of probability sections.

In the updating of the probability information, at least one of the probability section information and the representative probability information may be updated.

The updating of the probability information may include: deriving probability distribution information of bins for a previous codeword from the bitstream; and updating the probability information by using the derived probability distribution information.

The updating of the probability information may include: parsing header information included in the bitstream; and updating the probability information by using the parsed header information.

In another aspect, there is provided an entropy decoding apparatus. The apparatus includes: an updater updating probability information by using update information derived based on a bitstream received from an encoder; a bin decoder deriving a bin corresponding to a current codeword based on the updated probability information; and an inverse binarizer acquiring a syntax element by inversely binarizing the derived bin, wherein the probability information includes probability section information and representative probability information, the probability section information includes information on intervals between a plurality of probability sections and the number of the plurality of probability sections, and the representative probability information includes a representative probability for each of the plurality of probability sections.

The updater may update at least one of the probability section information and the representative probability information.

The updater may further include: a probability distribution calculator deriving probability distribution information of bins for a previous codeword from the bitstream; and an update informer deriving the update information by using the derived probability distribution information.

The updater may further include: a bitstream parser parsing header information included in the bitstream; and a update informer deriving the update information from the parsed header information.

In another aspect, there is provided an image decoding method. The method includes: updating probability information by using update information derived based on a bitstream received from an encoder; deriving a bin corresponding to a current codeword based on the updated probability information; and generating a reconstruction image by using a syntax element acquired from the derived bin, and the probability information includes probability section information and representative probability information, the probability section information includes information on intervals between a plurality of probability sections and the number of the plurality of probability sections, and the representative probability information includes a representative probability for each of the plurality of probability sections.

In the updating of the probability information, at least one of the probability section information and the representative probability information may be updated. The updating of the probability information may include: deriving probability distribution information of bins for a previous codeword from the bitstream; and updating the probability information by using the derived probability distribution information.

The updating of the probability information may include: parsing header information included in the bitstream; and updating the probability information by using the parsed header information.

### Advantageous Effects

According to an image encoding method of the present invention, image encoding/decoding efficiency can be improved.

According to an image decoding method of the present invention, image encoding/decoding efficiency can be improved.

According to an entropy encoding method of the present invention, image encoding/decoding efficiency can be improved.

According to an entropy decoding method of the present invention, image encoding/decoding efficiency can be improved.

### DESCRIPTION OF DRAWINGS

FIG. 1 is a block diagram showing a configuration of an image encoding apparatus according to an exemplary embodiment of the present invention.

FIG. 2 is a block diagram showing a configuration of an image decoding apparatus according to an exemplary embodiment of the present invention.

FIG. 3 is a schematic block diagram of a parallel entropy encoding apparatus according to an exemplary embodiment of the present invention.

FIG. 4 is a schematic block diagram of a parallel entropy decoding apparatus according to an exemplary embodiment of the present invention.

FIG. 5 is a schematic block diagram of a parallel entropy encoding apparatus according to another exemplary embodiment of the present invention.

FIG. 6 is a schematic block diagram of a parallel entropy decoding apparatus according to another exemplary embodiment of the present invention.

FIG. 7 is a schematic block diagram of a parallel entropy encoding apparatus according to yet another exemplary embodiment of the present invention.

FIG. 8 is a schematic block diagram of a parallel entropy decoding apparatus according to yet another exemplary embodiment of the present invention.

FIG. 9 is a schematic conceptual diagram of an exemplary embodiment of probability section and representative probability update.

FIG. 10 is a schematic conceptual diagram of an exemplary embodiment of representative probability update.

FIG. 11 is a schematic conceptual diagram of an exemplary embodiment of probability section update.

FIG. 12 is a flowchart schematically showing a parallel entropy encoding method according to an exemplary embodiment of the present invention.

FIG. 13 is a flowchart schematically showing a parallel entropy encoding method according to another exemplary embodiment of the present invention.

FIG. 14 is a flowchart schematically showing a parallel entropy decoding method according to an exemplary embodiment of the present invention.

### MODE FOR INVENTION

Hereinafter, exemplary embodiments according to the present invention will be described in detail with reference to the accompanying drawings. In describing exemplary embodiments of the present invention, well-known functions or constructions will not be described in detail since they may unnecessarily obscure the understanding of the present invention.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. Further, in the present invention, “comprising” a specific configuration will be understood that additional configuration may also be included in the exemplary embodiments or the scope of the technical idea of the present invention.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without being departed from the scope of the present invention and the ‘second’ component may also be similarly named the ‘first’ component.

Furthermore, constitutional parts shown in the embodiments of the present invention are independently shown so as to represent characteristic functions different from each other. Thus, it does not mean that each constitutional part is constituted in a constitutional unit of separated hardware or one software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

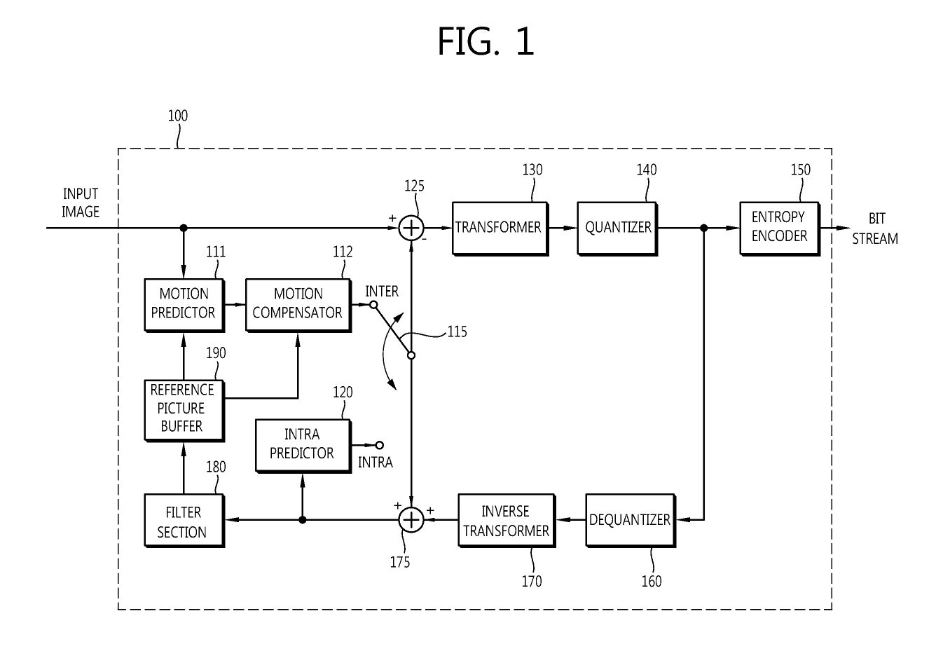

FIG. 1 is a block diagram showing a configuration of an image encoding apparatus according to an exemplary embodiment of the present invention.

Referring to FIG. 1, the image encoding apparatus 100 includes a motion predictor 111, a motion compensator 112, an intra predictor 120, a switch 115, a subtractor 125, a transformer 130, a quantizer 140, an entropy encoder 150, an inverse-quantizer 160, an inverse-transformer 170, an adder 175, a filter section 180, and a reference picture buffer 190.

The image encoding apparatus 100 may perform encoding in an intra-mode or an inter-mode and output a bitstream with respect to input images. In the intra-mode, a switch 115 may be switched to intra and in the case of the inter-mode, the switch 115 may be switched to inter. The image encoding apparatus 100 may generate a prediction block for an input block of the input images and thereafter, encode a residual between the input block and the prediction block.

In the case of the intra-mode, the intra predictor 120 may generate the prediction block by performing spatial prediction by using a pixel value of an already encoded block around a current block.

In the case of the inter-mode, the motion predictor 111 finds an area which matches the input block most appropriately in a reference image stored in the reference picture buffer 190 during a motion predicting process to acquire a motion vector. The motion compensator 112 performs motion compensation by using the motion vector to generate the prediction block.

The subtractor 125 may generate a residual block by using a residual between the input block and the generated prediction block. The transformer 130 transforms the residual block to output a transform coefficient. In addition, the quantizer 140 quantizes an inputted transform coefficient according to a quantization parameter to output a quantized coefficient.

The entropy encoder 150 performs entropy encoding based on values calculated by the quantizer 140 or encoded parameter values calculated during an encoding process to output the bitstream.

When the entropy encoding is applied, a small number of bits are allocated to a symbol having a high occurrence probability and a larger number of bits are allocated to a symbol having a low occurrence probability to express the symbol, thereby reducing the size of the bitstream for symbols to be encoded. Therefore, the compression performance of image encoding may be increased through entropy encoding. The entropy encoder 150 may use encoding methods such as exponential golomb, context-adaptive variable length coding (CAVLC), and context-adaptive binary arithmetic coding (CABAC) for entropy encoding.

Since the image encoding apparatus according to the exemplary embodiment of FIG. 1 performs inter prediction encoding, i.e., inter-screen prediction encoding, the current encoded image needs to be decoded and stored to be used as the reference image. Therefore, the quantized coefficient is inversely quantized by the inverse quantizer 160 and inversely transformed by the inverse transformer 170. Inversely quantized and inversely transformed coefficients are added to the prediction block through the adder 175, and as a result, a reconstructed block is generated.

The reconstructed block may pass through the filter section 180 and the filter section 180 may apply at least one of a deblocking filter, a sample adaptive offset (SAO), and an adaptive loop filter (ALF) to the reconstructed block or a reconstructed picture. The filter section 180 may be called an adaptive in-loop filter. The deblocking filter may remove block distortion generated on a boundary between blocks. The SAO may add an appropriate offset value to the pixel value in order to compensate a coding error. The ALF may perform filtering based on a value acquired by comparing an original image with a reconstructed image. The reconstructed block which passes through the filter section 180 may be stored in the reference picture buffer 190.

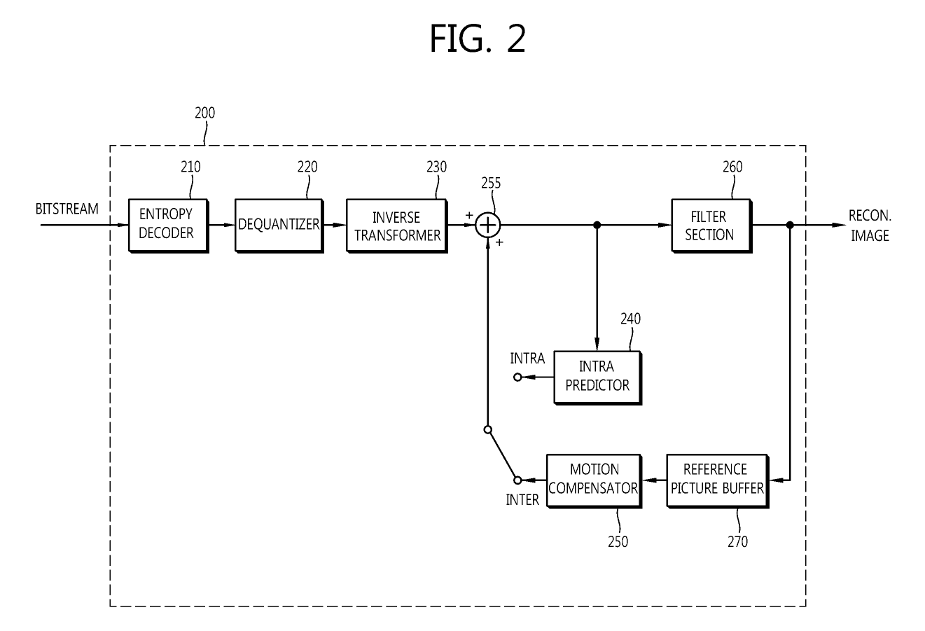

FIG. 2 is a block diagram showing a configuration of an image decoding apparatus according to an exemplary embodiment of the present invention.

Referring to FIG. 2, the image decoding apparatus 200 includes an entropy decoder 210, an inverse quantizer 220, an inverse transformer 230, an intra predictor 240, a motion compensator 250, an adder 255, a filter section 260, and a reference picture buffer 270.

The image decoding apparatus 200 may performs decoding in the intra-mode or inter-mode and output a reconstructed image, i.e., a reconstruction image by receiving the bitstream outputted from the encoder. In the case of the intra-mode, the switch is switched to the intra and in the inter-mode, the switch may be switched to the inter. The image decoding apparatus 200 acquires a reconstructed residual block from the received bitstream and generates the prediction block and thereafter, adds the reconstructed residual block and the prediction block to generate a reconstructed block, i.e., a reconstruction block.

The entropy decoder 210 entropy-decodes the received bitstream according to a probability distribution to generate symbols including a quantized coefficient type symbol. The entropy decoding method is similar to the entropy encoding method.

When the entropy decoding method is applied, the small number of bits are allocated to the symbol having the high occurrence probability and the larger number of bits are allocated to the symbol having the low occurrence probability to express the symbol, thereby reducing the size of the bitstream for each of the symbols. Therefore, the compression performance of image decoding may be increased through the entropy decoding method.

The quantized coefficient is inversely quantized by the inverse quantizer 220 and inversely transformed by the inverse transformer 230 and as the quantized coefficient is inversely quantized/inversely transformed, the reconstructed residual block may be generated.

In the case of the intra-mode, the intra predictor 240 may generate the prediction block by performing spatial prediction by using the pixel value of the already encoded block around the current block. In the case of the inter-mode, the motion compensator 250 may generate the prediction block by performing motion compensation by using the motion vector and the reference image stored in the reference picture buffer 270.

The reconstructed residual block and the prediction block are added to each other through the adder 255 and the added block may pass through the filter section 260. The filter section 260 may apply at least one of the deblocking filter, the SAO, and the ALF to the reconstruction block or reconstruction picture. The filter section 260 may output the reconstructed image, i.e., the reconstruction image. The reconstruction image is stored in the reference picture buffer 270 to be used for inter prediction.

As described above in FIGS. 1 and 2, the encoder and the decoder may perform entropy encoding and entropy decoding, respectively. When the entropy encoding/decoding is applied, the small number of bits are allocated to the symbol having the high occurrence probability and the larger number of bits are allocated to the symbol having the low occurrence probability to express the symbol, thereby reducing the size of the bitstream for the symbols to be encoded. The methods used for entropy encoding/decoding may include the exponential golomb, the CAVLC, and the CABAC.

For example, a table for performing entropy encoding/decoding such as a variable length coding (VLC) table may be stored in the encoder and the decoder and the encoder and the decoder may perform entropy encoding/decoding by using the stored VLC table.

The encoder and the decoder derives a binarization method of a target symbol and a probability model of a target symbol/bin and thereafter, may perform entropy encoding/decoding by using the derived binarization method or probability model.

Herein, binarization means that a value of the symbol is expressed as a binary sequence/string (bin sequence/string). The bin means each binary value (0 or 1) when the symbol is expressed as the binary sequence/string through binarization. The probability model means a predicted probability of a symbol/bin to be encoded/decoded which can be derived through context information/a context model. The context information/context model means information for determining the probability of the symbol/bin to be encoded/decoded.

More specifically, the CABAC entropy encoding method binarizes a unbinarized symbol to the bin, determine the context model by using encoding information of adjacent and encoding target blocks or information on the encoded symbol/bin encoded in the previous step, and arithmetically encodes the bin by predicting an occurrence probability of the bin according to the determined context model to generate the bitstream.

That is, the encoder/decoder performs entropy encoding/decoding effectively by using the encoding/decoding information of the adjacent block and the occurrence probability of the bin encoded/decoded in the previous step. Further in the encoding step, the encoder may select the context model through the encoding information of the adjacent block and update the occurrence probability information of the bin generated according to the selected context model.

In the case where a single encoder and/or a single decoder is used with respect to a UHD image having a size of HD or more, a workload required for a single processor is very large and an image processing speed may be low. Therefore, there can be provided a method of improving encoding efficiency by parallelizing the encoding and/or decoding process. To this end, there can be provided parallelizing methods for the process, which include motion compensation, image interpolation, discrete cosine transform (DCT), and the like and the parallelizing methods may be applied to even the entropy encoding/decoding process.

The parallel entropy encoding/decoding may be performed by using a plurality of entropy encoders and/or a plurality of entropy decoders. Further, the parallel entropy encoding/decoding may be performed based on a slice level.

A probability section of the bin may be divided according to a quantization section during slice-based parallel entropy encoding/decoding. The divided probability sections may be allocated to bin encoders corresponding to the probability sections in the encoder, respectively and allocated to bin decoders corresponding to the probability sections in the decoder. Further, representative probability values corresponding to the respective probability sections may be provided in the respective divided probability sections. The probability section divided according to the quantization section may be called a quantization section and/or a probability quantization section. Hereinafter, information on an interval for each of the plurality of probability sections and the number of the plurality of probability sections is referred to as probability section information and the representative probability for each of the plurality of probability sections is referred to as representative probability information.

Entropy encoding/decoding for the bin may be performed by a bin encoder/decoder to which the probability section corresponding to the occurrence probability of the bin is allocated. In this case, the bin encoder/decoder may perform entropy encoding/decoding of the inputted bin by using the representative probability value of the probability section. During the slice-based parallel entropy encoding/decoding, the encoder may transmit probability section information and representative probability information of the bin encoder corresponding to each probability section to the decoder based on the slice level.

During the parallel entropy encoding/decoding, entropy encoding/decoding for bins is performed by using a representative probability value of each bin encoder/decoder, not an actual occurrence probability value, and as a result, encoding performance may deteriorate due to the difference between the actual occurrence probability value and the representative probability value.

Further, the quantization interval and the representative probability value in each probability section may be determined based on the slice level. When the size of the image is large, the size of one slice may not be small and one frame may have one slice. Areas having different properties may be provided even in one slice and the quantization interval and representative probability value determined based on the slice level may be applied to areas having different properties similarly. When the same probability quantization interval and representative probability value are applied to all the areas in one slice, an image property may not sufficiently be reflected in units such as a bin and/or encoding unit smaller than the slice and total encoding efficiency may deteriorate.

Therefore, in order to minimize encoding loss generated by fixing the probability section and representative probability for the occurrence probabilities of the bins based on the slice level and sufficiently reflect the image property, the parallel entropy encoding/decoding method that adaptively updates the quantization interval of the plurality of probability sections, the number of probability sections, and/or the representative probability value corresponding to each of the probability sections may be provided.

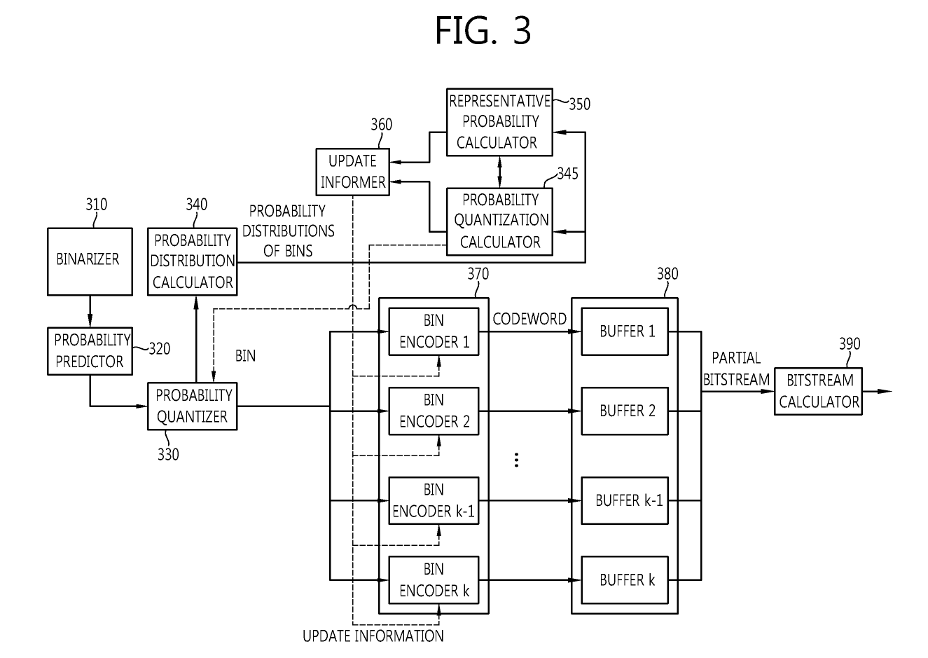

FIG. 3 is a schematic block diagram of a parallel entropy encoding apparatus according to an exemplary embodiment of the present invention. The parallel entropy encoding apparatus according to the exemplary embodiment of FIG. 3 may include a binarizer 310, a probability predictor 320, a probability quantizer 330, a probability distribution calculator 340, a probability quantization calculator 345, a representative probability calculator 350, an update informer 360, a bin encoder 370, a buffer 380, and a bitstream calculator 390.

The parallel entropy encoding apparatus according to the exemplary embodiment of FIG. 3 may include a plurality of bin encoders 370 in order to perform parallel entropy encoding and may update probability section information and representative probability information determined based on the slice level in order to improve encoding efficiency.

Referring to FIG. 3, the binarizer 310 may convert syntax elements into a bin string by using a predetermined binarization method. Herein, the bin string may be constituted by combining 0 and 1. The probability predictor 320 may predict an occurrence probability of 0 and/or 1 with respect to each bin.

The probability quantizer 330 may judge which quantization section and/or probability section each bin corresponds to by using the predicted occurrence probability of the bin. The probability quantizer 330 may determine the bin encoder 370 used in entropy encoding of each bin among the plurality of bin encoders according to the probability section corresponding to each bin. Further, the probability quantizer 330 may determine the probability section of the bin encoder 370 by using update information of the probability section.

The probability quantizer 330 may use the probability section information determined based on the slice level. In this case, the probability section may be an optimal probability section based on the slice level, but a spatial property may be different in each of the areas in one slice. Accordingly, using the fixed probability section determined based on the slice level may increase information volume in terms of an information theory and reduce encoding efficiency. In order to solve the problem, the parallel entropy encoding apparatus according to the exemplary embodiment of FIG. 3 may update the probability section information and the representative probability information by using the probability distribution calculator 340, the probability quantization calculator 345, the representative probability calculator 350, and the update informer 360.

When update information is inputted into the probability quantizer 330, the probability quantizer 330 may divide the probability section by using the update information. When the probability section is updated, the probability quantizer 330 may determine the bin encoder 370 used in entropy encoding of each bin by using the updated probability section.

The probability distribution calculator 340 may store information on probabilities of the encoded bins and calculate probability distributions of the bins. As one exemplary, the probability distribution calculator 340 may calculate the probability distributions by using a probability density function (PDF). Herein, the information on the probabilities of the bins including the probability distributions of the bins is referred to as bin probability information. The probability distribution calculator 340 may send the bin probability information to the probability quantization calculator 345 and the representative probability calculator 350.

The probability quantization calculator 345 may derive optimal probability section information depending on current probability distributions by using the bin probability information. The probability quantization calculator 345 may notify the derived probability section information to the probability quantizer 330 and the update informer 360. The representative probability calculator 350 may derive optimal representative probability information corresponding to each probability section by using the bin probability information. The representative probability calculator 350 may notify the derived representative probability information to the update informer 360.

The probability quantization calculator 345 and the representative probability calculator 350 may exchange information with each other. The probability quantization calculator 345 and the representative probability calculator 350 may derive optimal probability section information and representative probability information where compression rate is the maximum based on the exchanged information and the bin probability information received from the probability distribution calculator 340. The probability quantization calculator 345 and the representative probability calculator 350 may notify the derived information to the update informer 360.

The update informer 360 may derive update information by determining whether the probability section and the representative probability are updated based on the information received from the probability quantization calculator 345 and the representative probability calculator 350. The update informer 360 may notify the generated update information to the bin encoder 370.

As an exemplary, the update information may be derived in the encoder and the decoder by using the same algorithm. In this case, on the assumption that the decoder also includes the update informer, the update informer of the encoder and the update informer of the decoder may derive the update information by using the same algorithm. As another exemplary embodiment, the update information derived by the encoder is included in a header as additional information to be transmitted to the decoder.

The probability sections may be allocated to different bin encoders 370. That is, the bin encoders 370 may be classified according to the probability sections. The bins may be entropy-encoded by the bin encoders 370 corresponding to the bins according to the occurrence probabilities. The bin encoders 370 may transform binarized bins to codewords by using a mapping table corresponding to the representative probability.

The codewords outputted from the bin encoders 370 may be stored in the buffer 380. The codewords stored in the buffer may be transmitted to or stored in the decoding apparatus through the bitstream calculator 390 after one-slice encoding is terminated. In this case, the codewords stored in the buffer may be transmitted to the decoding apparatus together with header information and stored in the decoding apparatus together with the header information.

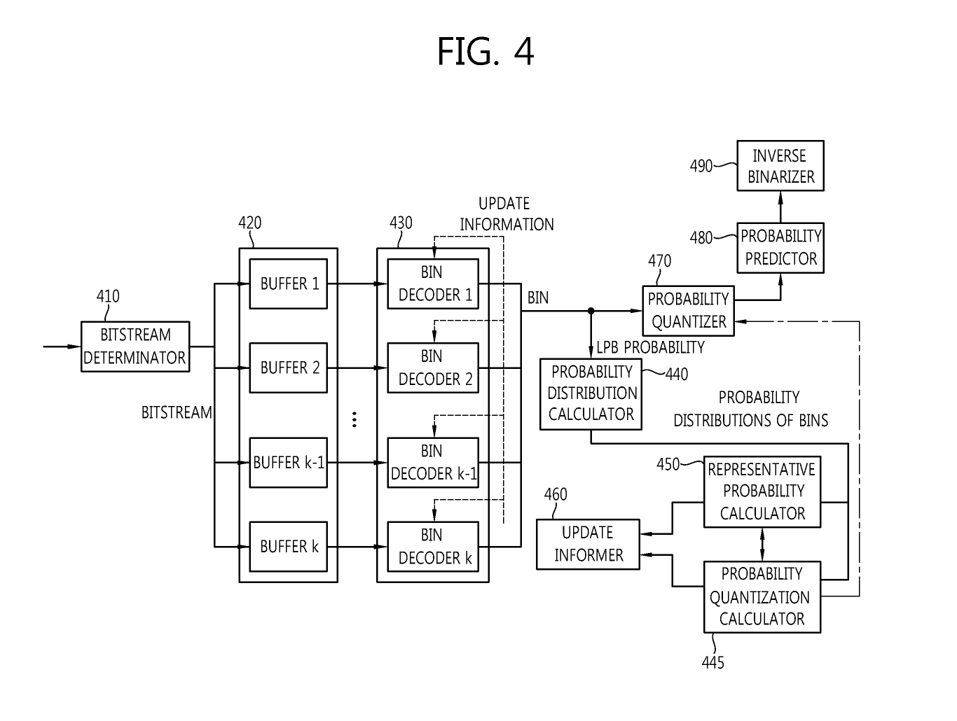

FIG. 4 is a schematic block diagram of a parallel entropy decoding apparatus according to an exemplary embodiment of the present invention. The parallel entropy decoding apparatus according to the exemplary embodiment of FIG. 4 may include a bitstream determinator 410, a buffer 420, a bin decoder 430, a probability distribution calculator 440, a probability quantization calculator 445, a representative probability calculator 450, an update informer 460, a probability quantizer 470, a probability predictor 480, and an inverse binarizer 490.

The parallel entropy decoding apparatus according to the exemplary embodiment of FIG. 4 may include a plurality of bin decoders 430 in order to perform parallel entropy decoding. The parallel entropy decoding apparatus according to the exemplary embodiment of FIG. 4 may decode the bitstream in parallel in order to improve encoding efficiency.

Referring to FIG. 4, the bitstream determinator 410 may receives the bitstream and thereafter, parse header information included in the bitstream and determine the bitstream inputted into each bin decoder 430. The buffer 420 may store the bitstream inputted into the bin decoder 430.

The bin decoder 430 may derive the codeword by parsing the bitstream and transform the codeword to the bin. In this case, the bin decoders 430 may transform the codeword to the bin by using the mapping table corresponding to the representative probability. That is, the bin decoder 430 may output the bin by performing entropy decoding of the inputted bitstream.

When the encoding apparatus performs parallel entropy encoding by using the adaptively updated probability section information and the adaptively updated representative probability information, a method and/or apparatus that can calculate update information of the probability section and the representative probability may be used even in the decoding apparatus. When the update information of the probability section and the representative probability are inputted into the bin decoder 430, the bin decoder 430 may perform the process by using the update information.

The parallel entropy decoding apparatus according to the exemplary embodiment of FIG. 4 may update the probability section information and the representative probability information by using the probability distribution calculator 440, the probability quantization calculator 445, the representative probability calculator 450, and the update informer 460 in order to reflect the spatial property of the image.

The probability distribution calculator 440 may store information on probabilities of the decoded bins by using the bins outputted from the bin decoder 430 and calculate the probability distributions of the decoded bins. As one exemplary, the probability distribution calculator 440 calculates the probability density function (PDF) by using a least probable bin (LPB) probability to derive the probability distributions. Herein, the LPB may mean a value of a bin which is the smaller between 0 and 1. The probability distribution calculator 440 may send the bin probability information to the probability quantization calculator 445 and the representative probability calculator 450.

The probability quantization calculator 445, for example, may derive the interval and number of optimal probability quantization sections depending on current probability distributions by using the bin probability information acquired from the probability distribution calculator 440. When the header include the update information of the probability quantization section, the bitstream determinator 410 parses the update information to send the parsed update information to the probability quantization calculator 445. In this case, the probability quantization calculator 445 may derive the optimal probability quantization section by using the parsed update information. The probability quantization calculator 445 may notify the derived probability section information to the update informer 460 and the probability quantizer 470. The probability quantizer 470 may determine the probability section of the bin decoder 430 by using the probability section information.

The representative probability calculator 450, for example, may derive the optimal representative probability corresponding to each probability section by using the bin probability information acquired from the probability distribution calculator 440. When the header include the update information of the representative probability, the bitstream determinator 410 parses the update information to send the parsed update information to the representative probability calculator 450. In this case, the representative probability calculator 450 may derive the optimal representative probability value by using the parsed update information. The representative probability calculator 450 may notify the derived representative probability information to the update informer 460.

The probability quantization calculator 445 and the representative probability calculator 450 may exchange information with each other. The probability quantization calculator 445 and the representative probability calculator 450 may derive optimal probability section information and representative probability information where compression rate is the maximum based on the exchanged information. The probability quantization calculator 445 and the representative probability calculator 450 may notify the derived information to the update informer 460.

When the update information is derived by parsing the header information, the update informer 460 may update the probability section and the representative probability by using the derived update information. The update informer 460 may notify the generated update information to the bin decoder 430.

When the update information is derived by using the bin probability information and/or a predetermined algorithm, the update informer 460 may select whether the probability section and the representative probability are updated. For example, the update informer 460 may perform the update process only when the difference between the current representative probability value and a newly derived representative probability value is larger than a threshold value. Herein, the threshold value may be for example, a predetermined threshold value or a threshold value determined in the encoder/decoder. The update informer 460 may select the optimal probability section and the representative probability value which can improve encoding efficiency through the process. The update informer 460 may transmit the update information including the update or not to the bin decoder 430.

The bins outputted from the bin decoder 430 may be decoded to a value of a meaningful syntax element through the probability quantizer 470, the probability predictor 480, and/or the inverse binarizer 490.

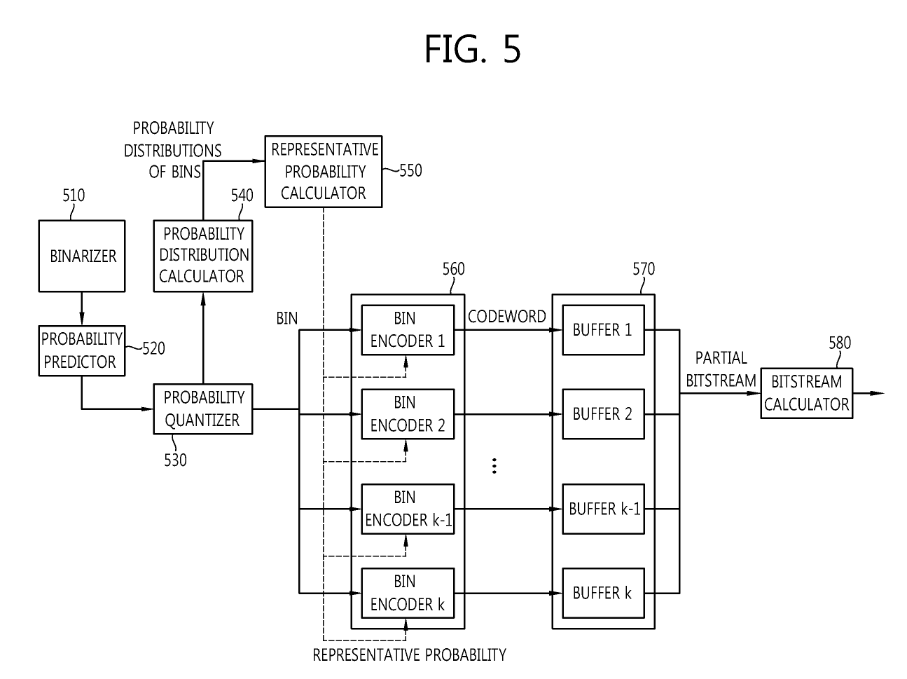

FIG. 5 is a schematic block diagram of a parallel entropy encoding apparatus according to another exemplary embodiment of the present invention. The parallel entropy encoding apparatus according to the exemplary embodiment of FIG. 5 may include a binarizer 510, a probability predictor 520, a probability quantizer 530, a probability distribution calculator 540, a representative probability calculator 550, a bin encoder 560, a buffer 570, and a bitstream calculator 580.

The parallel entropy encoding apparatus according to the exemplary embodiment of FIG. 5 may operate similarly as the parallel entropy encoding apparatus according to the exemplary embodiment of FIG. 3. However, the parallel entropy encoding apparatus according to the exemplary embodiment of FIG. 5 may fixedly uses the probability section determined based on the slice level and update only the representative probability.

Referring to FIG. 5, the representative probability calculator 550 may derive the optimal representative probability corresponding to each probability section by using the bin probability information acquired from the probability distribution calculator 540. The representative probability calculator 550 may use a predetermined algorithm at the time of deriving the representative probability.

The representative probability calculator 550 determines whether the representative probability is updated based on the derived representative probability information to derive the representative probability information including the update or not. As an example of determining the update or not, the representative probability calculator 550 may perform the update process only when the difference between the current representative probability value and a newly derived representative probability value is larger than a threshold value. Herein, the threshold value may be for example, a predetermined threshold value or a threshold value determined in the encoder/decoder. The representative probability calculator 550 may transmit the representative probability information including the update or not to the bin encoder 560.

As an exemplary, the representative probability information may be derived in the encoder and the decoder by using the same algorithm. In this case, on the assumption that the decoder also includes the representative probability calculator, the representative probability calculator 550 of the encoder and the representative probability calculator of the decoder may derive the representative probability information by using the same algorithm. As another exemplary embodiment, the representative probability information derived by the encoder is included in the header as the additional information to be transmitted to the decoder.

The representative probability values updated in the probability sections, respectively may be determined as the representative probability value of the bin encoder 560 corresponding to the probability section. The bin encoders 560 corresponding to each probability section may transform binarized bins to codewords by using the mapping table corresponding to the representative probability.

Since the rest of components other than the components described above in the exemplary embodiment of FIG. 5 are the same as those in the exemplary embodiment of FIG. 3, the rest of components will not be described.

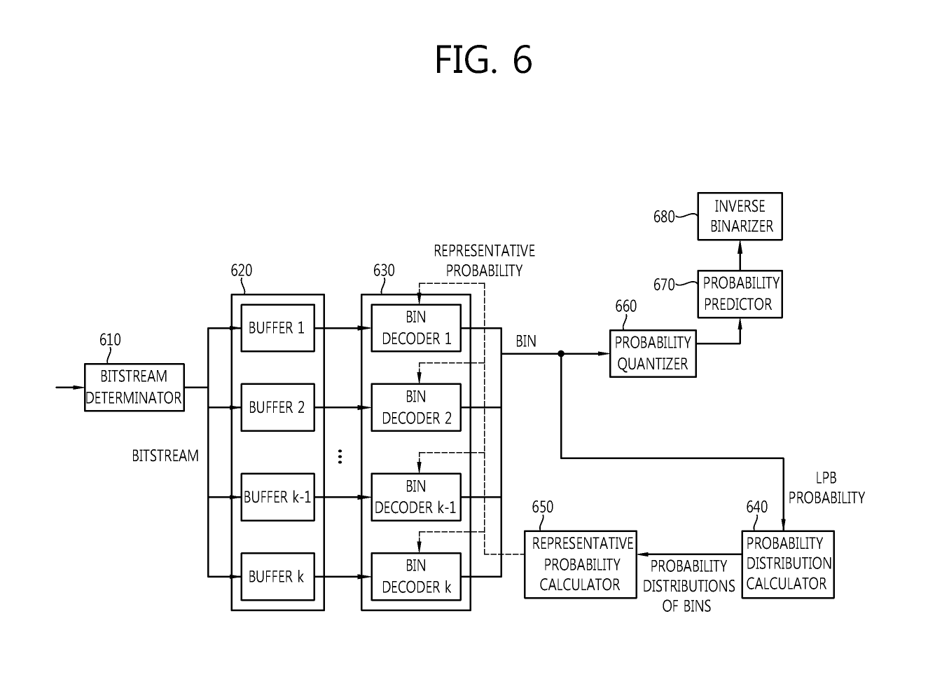

FIG. 6 is a schematic block diagram of a parallel entropy decoding apparatus according to another exemplary embodiment of the present invention. The parallel entropy decoding apparatus according to the exemplary embodiment of FIG. 6 may include a bitstream determinator 610, a buffer 620, a bin decoder 630, a probability distribution calculator 640, a representative probability calculator 650, a probability quantizer 660, a probability predictor 670, and an inverse binarizer 680.

The parallel entropy decoding apparatus according to the exemplary embodiment of FIG. 6 may operate similarly as the parallel entropy decoding apparatus according to the exemplary embodiment of FIG. 4. However, when the parallel entropy decoding apparatus according to the exemplary embodiment of FIG. 6 performs entropy decoding in one slice, the optimal probability section determined based on the slice level is fixedly used and only the representative probability may be updated in terms of increasing encoding efficiency.

Referring to FIG. 6, the representative probability calculator 650 may derive the optimal representative probability corresponding to each probability section by using the bin probability information acquired from the representative probability calculator 650. The representative probability calculator 650 may use a predetermined algorithm at the time of deriving the representative probability.

The representative probability calculator 650, for example, may derive the optimal representative probability corresponding to each probability section by using the bin probability information acquired from the probability distribution calculator 640. In this case, the representative probability calculator 650 may select whether the representative probability is updated. For example, the representative probability calculator 650 may perform the update process only when the difference between the current representative probability value and a newly derived representative probability value is larger than a threshold value. Herein, the threshold value may be for example, a predetermined threshold value or a threshold value determined in the encoder/decoder. The representative probability calculator 650 may transmit the representative probability information including the update or not to the bin decoder 630.

When the header information transmitted from the encoder includes the update information of the representative probability, the bitstream determinator 610 parses the update information to send the parsed update information to the representative probability calculator 650. In this case, the representative probability calculator 650 may update the representative probability by using the parsed update information.

Since the rest of components other than the components described above in the exemplary embodiment of FIG. 6 are the same as those in the exemplary embodiment of FIG. 4, the rest of components will not be described.

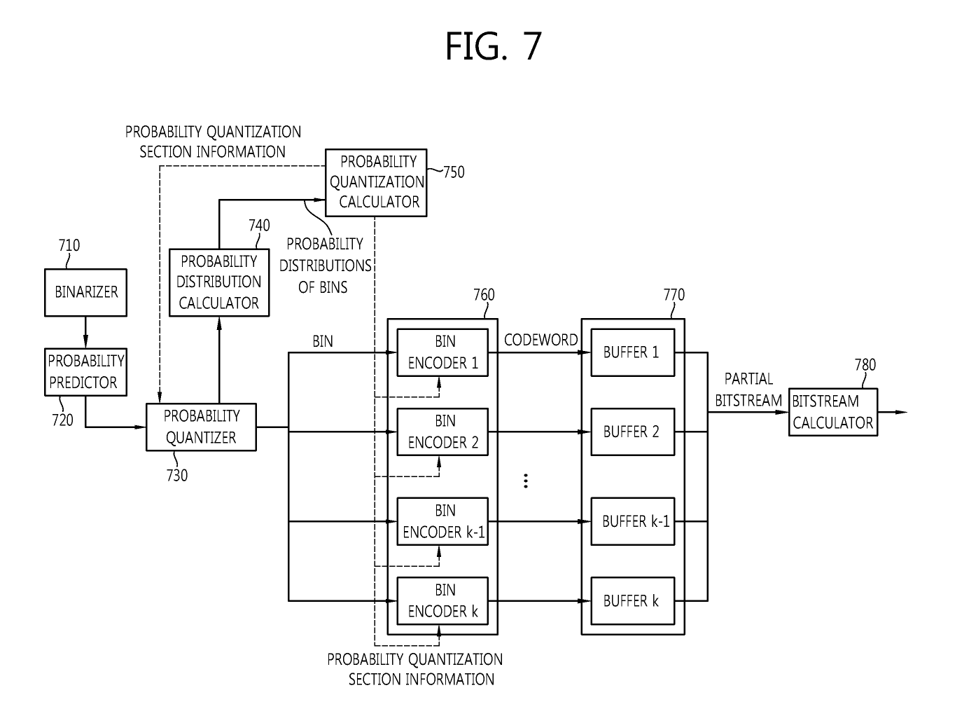

FIG. 7 is a schematic block diagram of a parallel entropy encoding apparatus according to yet another exemplary embodiment of the present invention. The parallel entropy encoding apparatus according to the exemplary embodiment of FIG. 7 may include a binarizer 710, a probability predictor 720, a probability quantizer 730, a probability distribution calculator 740, a probability quantization calculator 750, a bin encoder 760, a buffer 770, and a bitstream calculator 780.

The parallel entropy encoding apparatus according to the exemplary embodiment of FIG. 7 may operate similarly as the parallel entropy encoding apparatus according to the exemplary embodiment of FIG. 3. However, the parallel entropy encoding apparatus according to the exemplary embodiment of FIG. 7 may fixedly use the representative probability determined based on the slice level and adaptively update only the probability section.

Referring to FIG. 7, the probability quantization calculator 750 may receive the bin probability information from the probability distribution calculator 740. The probability quantization calculator 750 may derive the optimal probability section that can improve encoding efficiency to correspond to the fixed representative probability with respect to each bin encoder 760.

The probability quantization calculator 750 determines whether the probability section is updated based on the derived probability section to derive the probability section information including the update or not. As an example of determining the update or not, the probability quantization calculator 750 may update the probability section of the bin encoder only when the difference between the current probability section and a newly derived probability section is larger than a threshold value. Herein, the threshold value may be for example, a predetermined threshold value or a threshold value determined in the encoder/decoder. The probability quantization calculator 750 may transmit the probability section information including the update or not to the probability quantizer 730 and the bin encoder 760.

The probability quantizer 730 may determine the probability section of the bin encoder 760 by using update information of the probability section.

As an exemplary, the probability section information may be derived in the encoder and the decoder by using the same algorithm. In this case, on the assumption that the decoder also includes the probability quantization calculator, the probability quantization calculator 750 of the encoder and the probability quantization calculator of the decoder may derive the probability section information by using the same algorithm. As another exemplary embodiment, the probability section information derived by the encoder is included in the header as the additional information to be transmitted to the decoder.

Since the rest of components other than the components described above in the exemplary embodiment of FIG. 7 are the same as those in the exemplary embodiment of FIG. 3, the rest of components will not be described.

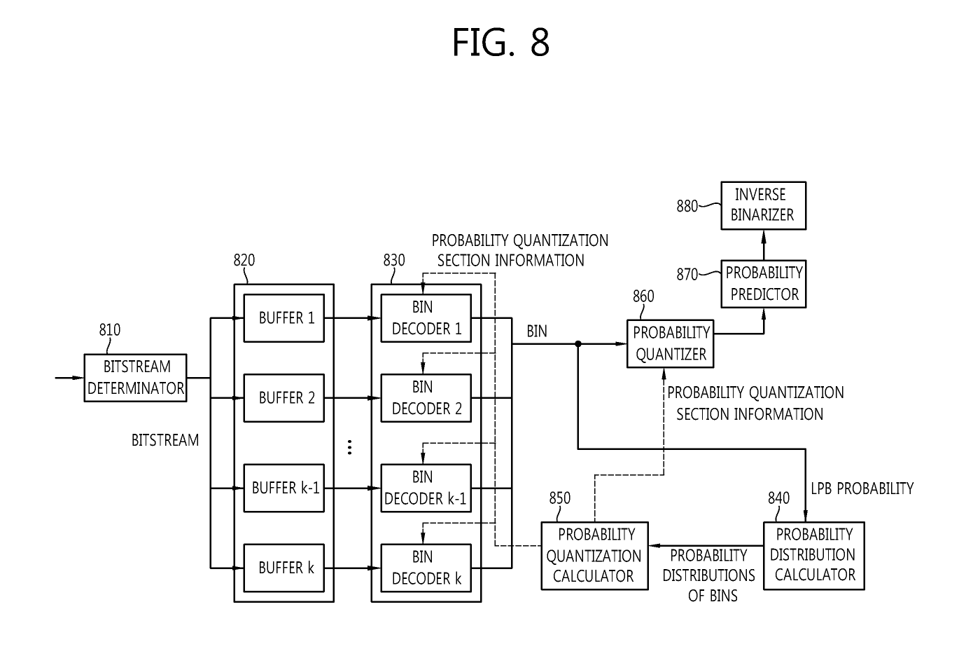

FIG. 8 is a schematic block diagram of a parallel entropy decoding apparatus according to yet another exemplary embodiment of the present invention. The parallel entropy decoding apparatus according to the exemplary embodiment of FIG. 8 may include a bitstream determinator 810, a buffer 820, a bin decoder 830, a probability distribution calculator 840, a probability quantization calculator 850, a probability quantizer 860, a probability predictor 870, and an inverse binarizer 880.

The parallel entropy decoding apparatus according to the exemplary embodiment of FIG. 8 may operate similarly as the parallel entropy decoding apparatus according to the exemplary embodiment of FIG. 4. However, the parallel entropy decoding apparatus according to the exemplary embodiment of FIG. 8 may fixedly use the representative probability determined based on the slice level and adaptively update only the probability section with respect to the fixed representative probability.

Referring to FIG. 8, the probability quantization calculator 850 may receive the bin probability information from the probability distribution calculator 840. The probability quantization calculator 850 may derive the optimal probability section that can improve encoding efficiency to correspond to the fixed representative probability with respect to each bin decoder 830.

The probability quantization calculator 850, for example, may derive the optimal probability section corresponding to each probability section by using the bin probability information acquired from the probability distribution calculator 840. In this case, the probability quantization calculator 850 may select whether the probability section is updated. For example, the probability quantization calculator 850 may perform the update process only when the difference between the current representative probability value and a newly derived representative probability value is larger than a threshold value. Herein, the threshold value may be for example, a predetermined threshold value or a threshold value determined in the encoder/decoder. The probability quantization calculator 850 may transmit the probability section information including the update or not to the bin decoder 830 and the probability quantizer 860.

The probability quantizer 860 may determine the probability section of the bin decoder 830 by using update information of the probability section.

When the header information transmitted from the encoder includes the update information of the probability section, the bitstream determinator 810 parses the update information to transmit the parsed update information to the probability quantization calculator 850. In this case, the probability quantization calculator 850 may update the probability section by using the parsed update information.

Since the rest of components other than the components described above in the exemplary embodiment of FIG. 8 are the same as those in the exemplary embodiment of FIG. 4, the rest of components will not be described.

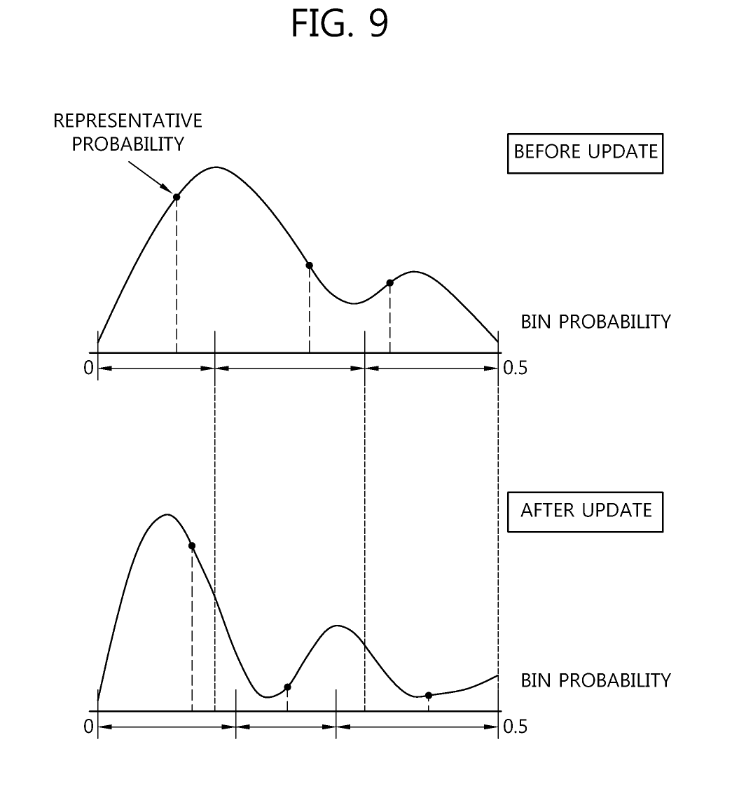

FIG. 9 is a schematic conceptual diagram of an exemplary embodiment of a probability section information and representative probability information update. The parallel entropy encoding apparatus according to the exemplary embodiment of FIG. 3 and the parallel entropy decoding apparatus according to the exemplary embodiment of FIG. 4 may perform the update as shown in the exemplary embodiment of FIG. 9.

In the exemplary embodiment of FIG. 9, a horizontal axis may represent the occurrence probability of the bin and a vertical axis may represent the number of occurrence times of the bin corresponding to the occurrence probability. Therefore, the exemplary embodiment of FIG. 9 may show the probability distributions of the bins.

The encoder and/or the decoder may find a new probability section a new representative probability and update the probability section and the representative probability that are determined based on the slice level in order to improve encoding efficiency. Referring to FIG. 9, the probability sections respectively corresponding to the bin encoders and/or the bin decoders and the representative probabilities respectively corresponding to the probability sections may be changed after the update.

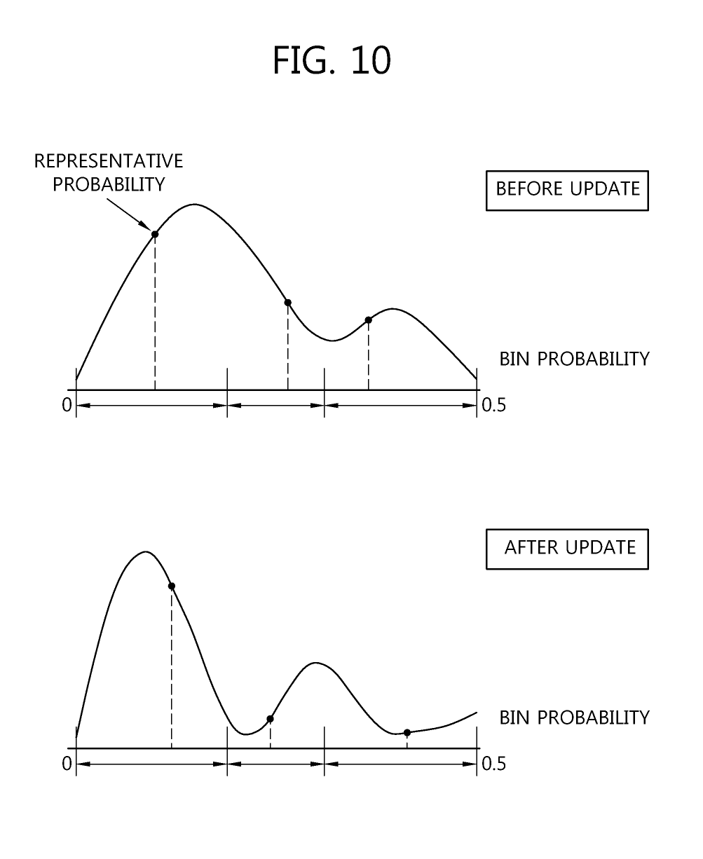

FIG. 10 is a schematic conceptual diagram of an exemplary embodiment of representative probability information update. The parallel entropy encoding apparatus according to the exemplary embodiment of FIG. 5 and the parallel entropy decoding apparatus according to the exemplary embodiment of FIG. 6 may perform the update as shown in the exemplary embodiment of FIG. 10.

In the exemplary embodiment of FIG. 10, a horizontal axis may represent the occurrence probability of the bin and a vertical axis may represent the number of occurrence times of the bin having the occurrence probability. Therefore, the exemplary embodiment of FIG. 10 may show the probability distributions of the bins.

The encoder and/or decoder may fixedly use the probability section determined based on the slice level and update only the representative probability in order to improve encoding efficiency. Referring to FIG. 10, the representative probabilities in the probability sections respectively corresponding to the bin encoders and/or the bin decoders may be changed after the update.

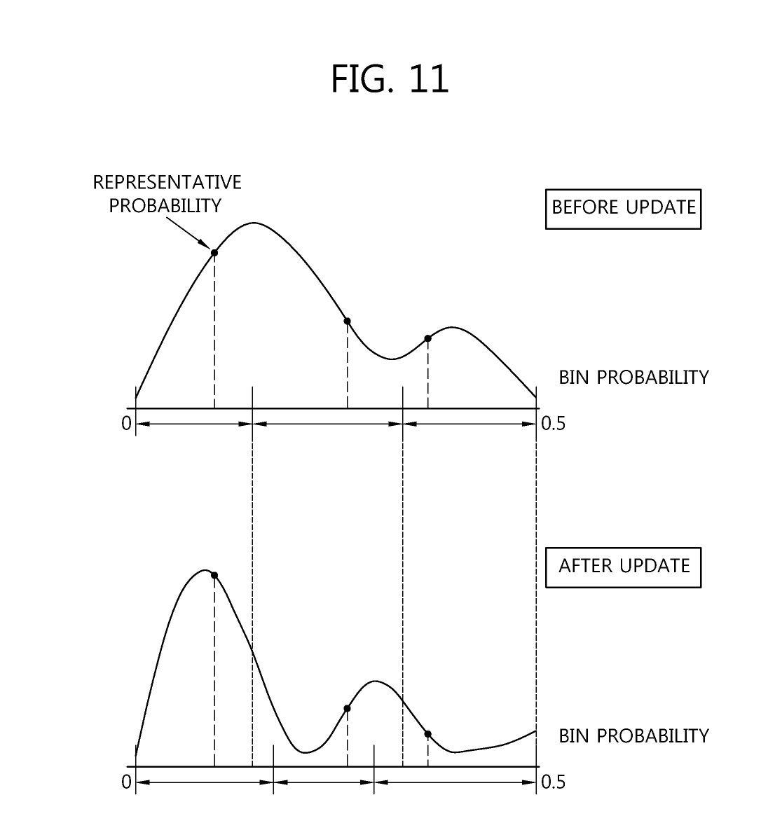

FIG. 11 is a schematic conceptual diagram of an exemplary embodiment of probability section information update. The parallel entropy encoding apparatus according to the exemplary embodiment of FIG. 7 and the parallel entropy decoding apparatus according to the exemplary embodiment of FIG. 8 may perform the update as shown in the exemplary embodiment of FIG. 11.

In the exemplary embodiment of FIG. 11, a horizontal axis may represent the occurrence probability of the bin and a vertical axis may represent the number of occurrence times of the bin having the occurrence probability. Therefore, the exemplary embodiment of FIG. 11 may show the probability distributions of the bins.

The encoder and/or decoder may fixedly use the representative probability determined based on the slice level and update only the probability section in order to improve encoding efficiency. Referring to FIG. 11, the probability sections respectively corresponding to the bin encoders and/or the bin decoders may be changed after the update.

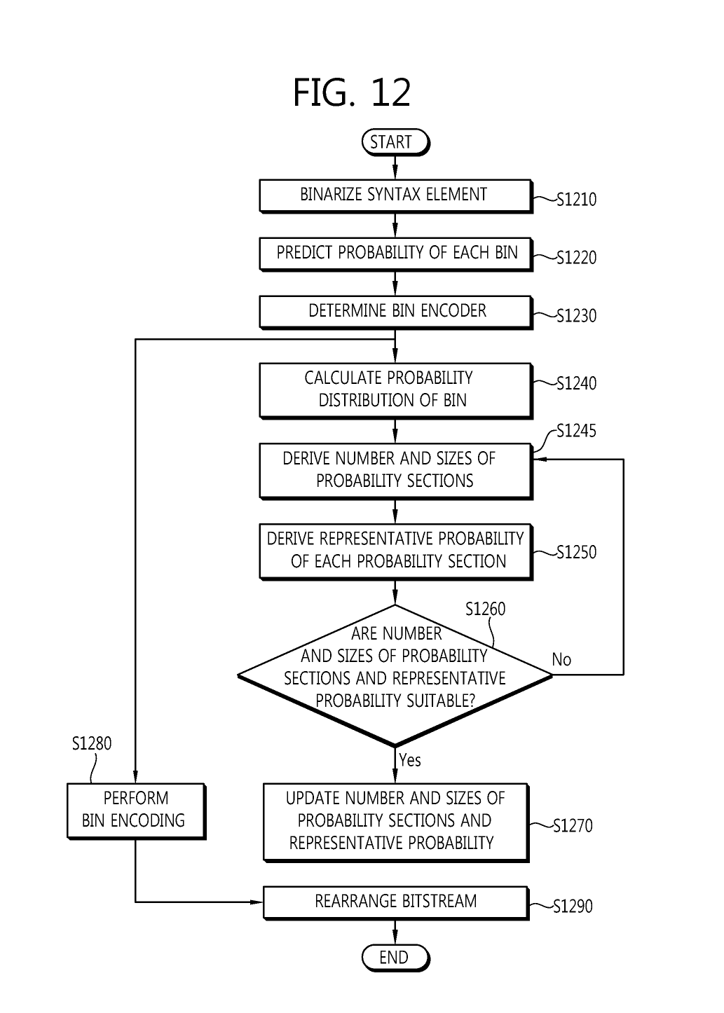

FIG. 12 is a flowchart schematically showing a parallel entropy encoding method according to an exemplary embodiment of the present invention.

Referring to FIG. 12, the encoder may convert syntax elements into bin strings by using a predetermined binarization method (S 1210). Herein, the bin string may be constituted by combining 0 and 1. Each of 0 and 1 may be called the bin and the bin may be used as a basic unit of entropy encoding/decoding.

The encoder may predict the occurrence probability for each bin for binary arithmetic encoding (S1220). The encoder may use information regarding an adjacent block of a current block and information regarding a current syntax element in order to predict the occurrence probability of the bin.

The probability section of the bin may be divided according to the quantization interval and the respectively divided probability sections may be allocated to the bin encoders corresponding to the respective probability sections. The encoder may determine the bin encoder used to entropy-encode each bin according to the probability section corresponding to the occurrence probability of each bin (S1230).

The encoder may store information on the probabilities of the encoded bins, i.e., the bin probability information and calculate the probability distributions (S 1240). The encoder may derive the number of the probability sections and the intervals between the probability sections by using the probability distributions (S 1245). Further, the encoder may derive the representative probabilities corresponding to the probability sections by using the probability distributions, respectively (S1250). Herein, a sequence of deriving the probability section information and the representative probability information may be changed and the encoder may derive only one kind of information between the probability section information and the representative probability information.

The encoder may judge whether the derived number of probability sections and the sizes of the probability sections and the representative probabilities respectively corresponding the probability sections are suitable for entropy encoding (S 1260). When the derived probability section information and/or representative probability information is not suitable for entropy encoding, the encoder may repeat the probability section information deriving process and the representative probability information deriving process. The number of the probability sections, the sizes of the respective probability sections, and the representative probabilities corresponding to the respective probability sections may have close relationships with each other, and as a result, the encoder may repeat the deriving processes in order to improve encoding efficiency and derive an optimal value.

When the derived probability section information and/or representative probability information is suitable for entropy encoding, the encoder may update the number of the probability sections and the sizes of the probability sections, and the representative probability corresponding to the respective probability sections (S 1270). The number of updated probability sections and the sizes of the updated probability sections and/or the updated representative probabilities may be used to entropy-encode bins updated after the update in order to improve encoding efficiency.

After the bin encoder used for entropy encoding of each bin is determined, the encoder may perform bin encoding for each bin by using the probability section and the representative probability (S 1280). The encoder performs bin encoding to transform the binarized bins to the codewords. The encoder may rearrange the bitstream in order to increase an output speed in decoding (S 1290).

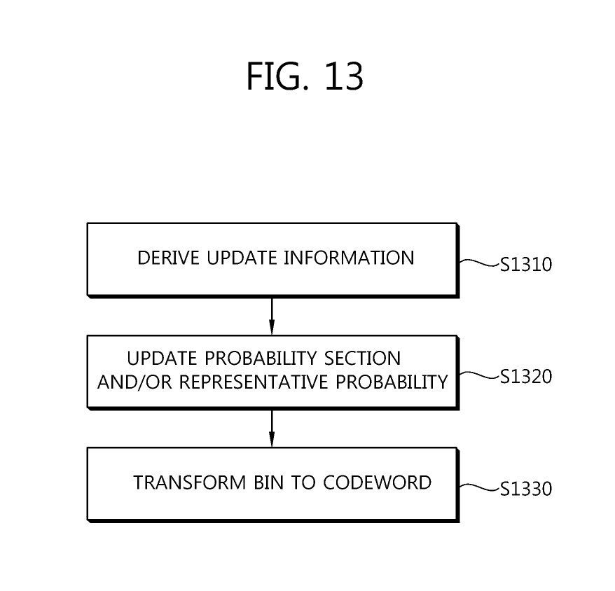

FIG. 13 is a flowchart schematically showing a parallel entropy encoding method according to another exemplary embodiment of the present invention.

Referring to FIG. 13, the encoder may derive update information of the probability section and the representative probability (S1310). As described above, the encoder may store information on the probabilities of the encoded bins and calculate the probability distributions of the bins. The encoder may derive update information by using the bin probability information including the probability distributions of the bins. Herein, the update information may include information on the number of the probability sections and the interval between the probability sections, the representative probability value corresponding to each probability section and/or the update or not. The derived update information is included in the header as the additional information to be transmitted to the decoder.

The encoder may update the number of the probability sections, the interval between the probability sections, and the representative probability corresponding to each probability section by using the derived update information (S 1320). The update probability section information and/or representative probability information may be used to entropy-encode bins inputted after the update.

The encoder may transform an encoding target bin to a codeword by using the updated probability section information and/or the updated representative probability information (S 1330).

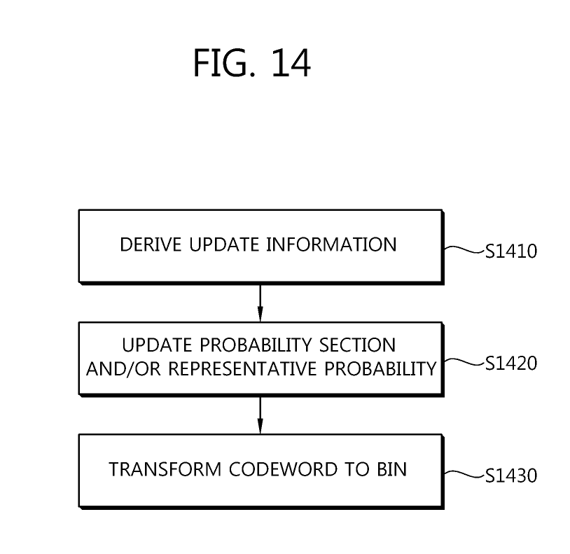

FIG. 14 is a flowchart schematically showing a parallel entropy decoding method according to an exemplary embodiment of the present invention.

Referring to FIG. 14, the decoder may derive update information of the probability section and the representative probability (S 1410).

As an exemplary, the decoder may derive the update information by using the same algorithm as the encoder. As described above, the decoder may store information on the probabilities of the decoded bins and calculate the probability distributions of the decoded bins. The decoder may derive update information by using the bin probability information including the probability distributions of the bins. Herein, the update information may include information on the number of the probability sections and the interval between the probability sections, the representative probability value corresponding to each probability section and/or the update or not.

As another exemplary embodiment, the decoder parses the header information transmitted from the encoder to derive the update information. As described above, the update information derived by the encoder is included in the header as the additional information to be transmitted to the decoder. In this case, the decoder parses the header information to acquire the update information.

The decoder may update the number of the probability sections, the interval between the probability sections, and/or the representative probability corresponding to each probability section by using the derived update information (S1420). The decoder may transform the codeword to the bin by using the updated probability section information and/or the updated representative probability information (S 1430). In this case, the decoder may use a mapping table corresponding to the updated representative probability.

According to the exemplary embodiments, when parallel entropy encoding/decoding is performed, the number of the probability sections, the interval between the probability sections, and/or the representative probability value corresponding to each probability section can be adaptively updated. Accordingly, properties for the occurrence probabilities of the bins and/or the probability distributions of the bins can be sufficiently reflected in entropy encoding/decoding and encoding/decoding efficiency can be improved.

In the above-mentioned exemplary system, although the methods have described based on a flow chart as a series of steps or blocks, the present invention is not limited to a sequence of steps but any step may be generated in a different sequence or simultaneously from or with other steps as described above. Further, it may be appreciated by those skilled in the art that steps shown in a flow chart is non-exclusive and therefore, include other steps or deletes one or more steps of a flow chart without having an effect on the scope of the present invention.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

1. An entropy decoding method, comprising:
updating probability information by using update information derived based on a bitstream received from an encoder;
deriving a bin corresponding to a current codeword based on the updated probability information; and
acquiring a syntax element by inversely binarizing the derived bin,
wherein the probability information includes probability section information and representative probability information, the probability section information includes information on intervals for each of a plurality of probability sections and the number of the plurality of probability sections, and the representative probability information includes a representative probability for each of the plurality of probability sections.

2. The entropy decoding method of claim 1, wherein in the updating of the probability information, at least one of the probability section information and the representative probability information is updated.

3. The entropy decoding method of claim 1, wherein the updating of the probability information includes:
deriving probability distribution information of bins for a previous codeword from the bitstream; and
updating the probability information by using the derived probability distribution information.

4. The entropy decoding method of claim 1, wherein the updating of the probability information includes:
parsing header information included in the bitstream; and
updating the probability information by using the parsed header information.

5. An entropy decoding apparatus, comprising:
an updater updating probability information by using update information derived based on a bitstream received from an encoder;
a bin decoder deriving a bin corresponding to a current codeword based on the updated probability information; and
an inverse binarizer acquiring a syntax element by inversely binarizing the derived bin,
wherein the probability information includes probability section information and representative probability information, the probability section information includes information on intervals for each of a plurality of probability sections and the number of the plurality of probability sections, and the representative probability information includes a representative probability for each of the plurality of probability sections.

6. The entropy decoding apparatus of claim 5, wherein the updater updates at least one of the probability section information and the representative probability information.

7. The entropy decoding apparatus of claim 5, wherein the updater further includes:
a probability distribution calculator deriving probability distribution information of bins for a previous codeword from the bitstream; and
an update informer deriving the update information by using the derived probability distribution information.

8. The entropy decoding method of claim 5, wherein the updater further includes:
a bitstream parser parsing header information included in the bitstream; and
a update informer deriving the update information from the parsed header information.

9. An image decoding method, comprising:
updating probability information by using update information derived based on a bitstream received from an encoder;
deriving a bin corresponding to a current codeword based on the updated probability information; and
generating a reconstruction image by using a syntax element acquired from the derived bin,
wherein the probability information includes probability section information and representative probability information, the probability section information includes information on intervals for each of a plurality of probability sections and the number of the plurality of probability sections, and the representative probability information includes a representative probability for each of the plurality of probability sections.

10. The entropy decoding method of claim 9, wherein in the updating of the probability information, at least one of the probability section information and the representative probability information is updated.

11. The image decoding method of claim 9, wherein the updating of the probability information includes:
deriving probability distribution information of bins for a previous codeword from the bitstream; and
updating the probability information by using the derived probability distribution information.

12. The image decoding method of claim 9, wherein the updating of the probability information includes:
parsing header information included in the bitstream; and
updating the probability information by using the parsed header information.
